(19) United States
(12) Patent Application Publication
(10) Pub. No.: US 2018/0190456 A1
(43) Pub. Date: Jul. 5, 2018

(54) ELECTRICAL SUPPLY CONTINUITY MODULE, SYSTEM AND METHOD

(71) Applicant: SmartSwitch Pty Ltd, Brighton (AU)

(72) Inventor: Gavin Pearce, Brighton (AU)

(21) Appl. No.: 15/897,775

(22) Filed: Feb. 15, 2018

Related U.S. Application Data
(63) Continuation of application No. PCT/AU2016/050758, filed on Aug. 16, 2016.

(30) Foreign Application Priority Data
Aug. 16, 2015 (AU) 2015903345
Jun. 28, 2016 (AU) 2016902523

(51) Int. Cl. H01H 43/00

(52) U.S. Cl. CPC H01H 43/00; H05B 37/0281

(57) ABSTRACT

An electrical power supply continuity module for an electrical power supply timer operable with an electrical outlet device, the electrical power supply timer having at least one scheduled switch off period for stopping electrical power supply through the electrical outlet device, the electrical power supply continuity module operable with a sensor for sensing electrical power supplied to an electrical apparatus by the electrical outlet device, wherein the electrical power supply continuity module is operable to receive from the sensor an indication of electrical power supply to an electrical apparatus at a chosen time before a scheduled switch off period of the electrical power supply timer, the continuity module operable to override at least part of the scheduled switch off period such that electrical power is supplied during at least part of the scheduled switch off period.

### CROSS REFERENCE TO RELATED APPLICATIONS

Continuation of International Application No. PCT/AU2016/050758 filed on Aug. 16, 2016. Priority is claimed from Australian Application No. 2015903345 filed on Aug. 18, 2015 and Australian Application No. 2016902523 filed on Jun. 28, 2016. All of the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of means and methods for continuing electrical power supply to an electrical apparatus. The disclosure more specifically relates to devices, systems and methods used for timed control of electrical power supply.

Electrical power is expensive to generate and for consumers to purchase. Electricity may be produced by polluting methods, such as burning coal, or dangerous methods, such as nuclear fission. There is, therefore, a desire to reduce the amount of electricity consumed, so as to reduce costs in production and costs to consumers, and to reduce pollution.

One way of reducing consumption of electrical power is by use of timers, which are set to automatically switch on and switch off electrical power supply to an electrical apparatus, such as a lamp, a television or any other such apparatus. The timers (which may also be referred to as electrical control devices, electrical supply timers, or electrical power supply timers) may be settable with one or more cycles of on and off times for the electrical power supply. Typically, such timers have pins that are plugged in to, for example, a domestic-type power outlet (also referred to as a power point, a GPO, or a general power outlet) and also has one or more power outlet ports, with the electrical apparatus to receive the power supply plugged in to one of the power outlet ports. Some timers are in the form of a unit that plugs directly in to a power outlet, others are in the form of a power board with an electrical cord that is plugged in to the power outlet. Recently, timers have been developed, which are embedded in the power outlet. Other timers may be associated with different kinds of electrical supply switches, such as light switches.

Some power outlets (GPOs) do not have manual switches for turning the power supply on and off. Instead, these types of non-manual-switch power outlets can be operated by plugging in an electrical apparatus, which immediately receives power supply upon being plugged in, and unplugging the electrical apparatus stops the power supply to the apparatus. This type of outlet is sometimes referred to as an “always on” outlet.

Power outlets (whether having manual on/off switches or being of the “always on” type) and other electrical supply switches, such as light switches, are referred to collectively as electrical outlet devices.

Timers may be manually set by movement of dials, levers, switches and the like. Other timers are set or programmed with a graphical user interface located on the timer. Recently, other timers have been developed, which are programmable via external programming devices, such as computers, laptops, smart phones, computer tablets, and the like. Timers typically have at least one scheduled on period during which electrical power is suppliable or supplied through to an electrical apparatus (sometimes this requires that the electrical outlet device is also switched on if having manual on/off switches, but if the electrical outlet device is a non-manual-switch “always on” device, then the timer will supply electrical power when during its on period) and at least one scheduled off period during which electrical power is not suppliable or supplied to the electrical apparatus (whether the electrical outlet device is switched on or off if having manual on/off switches, or the electrical outlet device is a non-manual-switch “always on” device).

Many electrical apparatuses, including televisions, stereo systems, kitchen appliances and other domestic or non-domestic electrical apparatuses, use standby power to be responsive to remote controls, or to be ready to use if desired. Unfortunately, standby power can use a lot of electrical energy, and this can lead to a great deal of electrical power wastage, especially when adding all the standby electrical power used by all electrical apparatuses in a house over a year. Such wastage is undesirable because of potential harm to the environment caused by electrical power generation by non-renewable resources, such as coal, and the wasted power can be very costly for the consumer.

Timers have an advantage in being able to save electrical power wastage in electrical apparatuses that have standby power by switching off the power supply to the apparatus at times when the apparatus is not likely to be used. For example, most people do not want to listen to their stereo system between the hours of 10.00 pm and 5.00 am. A timer can switch off the electrical power supply to the stereo system for an off period so that the standby power is not consuming the electricity during that period, and switch on the power supply the next morning for an on period so that the stereo system is ready to use if desired.

Generally, a timer is settable or programmable with at least one on period and at least one off period within a 24-hour cycle. The setting or program is repeated every 24-hour cycle to turn on and turn off power supply at the same times within the cycle. Other more sophisticated timers provide setting or programming for multiple on and off periods in a 24-hour cycle, and may provide for different settings or programs on different days of the week, month or year so as to allow many options for a user.

Typically, the timer will turn off electrical power supply at a scheduled time, even if the power supply through the electrical outlet device is still switched on, or would be always on if the device is a non-manual-switch outlet when the apparatus is plugged in. However, though the electrical outlet device is switched on (or is an “always on” non-manual-switch electrical outlet device), the electrical power supply is not being consumed during the supply off period, for example, by an apparatus plugged in to the timer, as the timer does not allow the electrical power supply through from the electrical outlet device to the apparatus during that off period. Some more recent timers, for example, those built in to an electrical outlet device can operate to stop the electrical power supply being provided by the electrical outlet device during the supply off period, and cannot be readily bypassed simply by unplugging the timer from the electrical outlet device and plugging the apparatus directly in to the electrical outlet device.

In one use scenario, a user might plug a timer in to an electrical outlet device and plug a lamp into the timer, the user sets one on time, for example 6.00 am, and one off time, for example 8.00 am, such that an electrical apparatus will switch on for a two-hour period at 6.00 am and switch off at 8.00 am. As such, the timer has a two hour on period between 6.00 am and 8.00 am, and a 22 hour off period between 8.00 am and 6.00 am the next day. If a lamp is plugged in to the timer or to a power outlet incorporating a timer, and the lamp itself is switched on, then the light in the lamp will be on for that two-hour period. At the end of the on period, if the lamp is still switched on, it will automatically be switched off by the timer. This may be inconvenient, for example, if someone desires that the lamp actually stays on longer than would be permitted by the automatic timer.

Similarly, if another electrical apparatus, such as a television set, is plugged in to the timer or the electrical outlet device incorporating the timer, and the television is turned on at some time during the two-hour time period, then the television will have power until the switch off time at 8.00 am, at which time the timer will turn off the electrical power supply to the television and the television will turn off.

If somebody is watching television at the switch off time, having the power supply turn off may be very inconvenient or annoying, and the person would then have to reset or reprogram the timer, or bypass the timer, if possible, by plugging the television in to another electrical outlet device, or, if the timer is an externally mounted timer, unplugging the timer from the electrical outlet device and plugging the television straight in to the electrical outlet device. This is undesirable and has led to some people not using timers for electrical apparatuses, such as televisions or computers and other devices that typically consume standby electrical power, and so the electrical apparatuses may be left with standby power on which leads to the wastage of electricity. In particular, when working with a computer, a user may lose unsaved work if power supply to the computer is turned off automatically by a timer.

Another problem with sudden stoppage of electrical power to some electrical apparatuses which are in a fully on state is that they will likely suffer damage if subjected to such shut downs. The risk of damage is increased with such shut downs being performed by a timer repeatedly over an extended period of time. However, an apparatus which is in a standby power state will not likely suffer such damage if subjected to stoppage of electrical power supply by the timer.

A further problem is that a timer may switch off (or enter into a switched off period) when an apparatus, such as a laptop computer, a tablet computer, or a mobile telephone, is recharging. The apparatus may itself be off at the time of charging, however, it will generally be desired to maintain power supply to keep recharging the battery of the apparatus. The loss of power supply during recharging a battery can lead to an insufficiently charged battery, and can also shorten battery life for some types of rechargeable battery.

Accordingly, it has been identified as useful to provide a means and method for preventing the inconvenience and potential damage of sudden and/or unanticipated shutdown of electrical power supply to an apparatus by a timer when said apparatus is in an on state.

It has also been identified as useful that the means and method should allow the timer to shutdown electrical power supply if an apparatus is off or in standby power mode.

### SUMMARY

In one aspect, the present disclosure describes an electrical power supply continuity module for an electrical power supply timer operable with an electrical outlet device, the electrical power supply timer having at least one scheduled switch off period for stopping electrical power supply through the electrical outlet device, the electrical power supply continuity module operable with a sensor for sensing electrical power supplied to an electrical apparatus by the electrical outlet device, wherein the electrical power supply continuity module is operable to receive from the sensor an indication of electrical power supply to an electrical apparatus at a chosen time before a scheduled switch off period of the electrical power supply timer, the continuity module operable to override at least part of the scheduled switch off period such that electrical power is supplied during at least part of the scheduled switch off period.

In yet another aspect, the present disclosure describes a method including receiving an indication of sensed electrical power supplied to an electrical apparatus from an electrical outlet device operating with an electrical power supply timer, wherein, if the electrical power supply is sensed at a chosen time before a scheduled switch off period of the electrical power supply timer, at least part of the scheduled switch off time is overridden such that the electrical power continues to be supplied during the at least part of the scheduled switch off period.

In yet another aspect, the present disclosure describes a system enabled to provide electrical power supply continuity including an electrical power supply continuity module and an electrical power supply timer, wherein the continuity module includes a sensor for sensing if electrical power is being supplied to an electrical apparatus from an electrical outlet device operating with the electrical power supply timer, wherein, in use, if the sensor senses electrical power supply to the apparatus at a chosen time before a scheduled switch off period of the timer, the continuity module overrides at least part of the scheduled switch off period such that the electrical power continues to be supplied during the at least part of the scheduled switch off period.

A system enabled to provide electrical power supply continuity including an electrical power supply continuity module for an electrical power supply timer operable with an electrical outlet device, the electrical power supply timer having at least one scheduled switch off period for stopping electrical power supply through the electrical outlet device, the electrical power supply continuity module operable with a sensor for sensing electrical power supplied to an electrical apparatus by the electrical outlet device, wherein the electrical power supply continuity module is operable to receive from the sensor an indication of electrical power supply to an electrical apparatus at a chosen time before a scheduled switch off period of the electrical power supply timer, the continuity module operable to override at least part of the scheduled switch off period such that electrical power is supplied during at least part of the scheduled switch off period, the system further including the electrical power supply timer.

A system enabled to provide electrical power supply continuity including an electrical power supply continuity module for an electrical power supply timer operable with an electrical outlet device, the electrical power supply timer having at least one scheduled switch off period for stopping electrical power supply through the electrical outlet device, the electrical power supply continuity module operable with a sensor for sensing electrical power supplied to an electrical apparatus by the electrical outlet device, wherein the electrical power supply continuity module is operable to receive from the sensor an indication of electrical power supply to an electrical apparatus at a chosen time before a scheduled switch off period of the electrical power supply timer, the continuity module operable to override at least part of the scheduled switch off period such that electrical power is supplied during at least part of the scheduled switch off period, the system further including the sensor.

In one or more embodiments, the electrical power supply continuity module is a software module adapted to receive input from the sensor and to provide output to the electrical supply timer. In such embodiments, the software module may be implemented on a general purpose computing device, a central processing unit (CPU) chip, a custom chip, a custom chip set, a custom circuit, or any other suitable hardware. In yet other embodiments, the electrical power supply continuity module may be implemented as hardware using suitable electrical and electronic components. In yet further embodiments, the electrical power supply continuity module may be implemented using both hardware and software components.

In one or more other embodiments, the electrical power supply continuity module is a hardware device or a component of a hardware device

In an embodiment, the continuity module is adapted to allow the override if the sensor senses electrical power supply to the apparatus at or above a power threshold. Optionally, the power threshold is chosen. The chosen threshold may be pre-set, or set by a user.

In another embodiment, the power threshold is calculated from a chosen or a measured standby power supply level. The calculation may include a chosen additional amount above the chosen or the measured standby power supply level.

In yet another embodiment, the power threshold is calculated by measuring standby power supply level of an apparatus over a chosen period and determining an average standby power supply level over that period. Measuring the standby power supply level may also include determining a difference between standby power supply level and non-standby power supply level of the apparatus. Further, the difference between standby power supply level and non-standby power supply level may be determined by periodically measuring substantially instantaneous power supply over the chosen period, counting the number of times the instantaneous power supply level is within one of a plurality of chosen power level bands, defining that the standby power supply level is at or below a chosen point between higher power level bands having a high count and lower power level bands having a high count, and defining that non-standby power supply level is above the chosen point. Moreover, the calculation may include a given additional amount above the determined average standby power level.

In a further embodiment, the continuity module includes memory and a processor. Optionally, any one or more of setting the threshold, pre-setting the threshold, storing the expected standby power supply level, storing the chosen additional amount, storing the chosen period, determining the average, calculating the threshold, measuring the standby power level, storing the chosen power level bands, defining the standby and non-standby power supply level, and determining a difference, are performed by the continuity module using the memory and/or the processor.

In yet a further embodiment, the sensor senses electrical power supply to the apparatus between notional commencement of the scheduled switch off period and commencement of a next scheduled switch on period of the electrical power supply timer, and, if the sensor senses no electrical power supply to the apparatus or senses power supply below a chosen level defined as being no electrical power supply to the apparatus, a switch off period of the electrical power supply timer is commenced. Further, the sensor may sense electrical power supply to the apparatus between notional commencement of the scheduled switch off period and commencement of a next scheduled switch on period, and, if the sensor senses power supply to the apparatus below the threshold, a switch off period is commenced. Optionally, the commenced switch off period is the originally scheduled switch off period. Alternatively, the commenced switch off period could finish before or after an end of the originally scheduled switch off period. In these embodiments, the sensing after the notional commencement of the scheduled switch off period may be periodical.

In an embodiment of the system, the system further includes the electrical outlet device.

In another embodiment, the present disclosure describes an electrical power supply continuity module including a sensor for sensing if electrical power is being supplied to an electrical apparatus from an electrical outlet device operating with an electrical power supply timer, wherein, in use, if the sensor senses electrical power supply to the apparatus at a chosen time before a scheduled switch off period of the timer, the continuity module overrides at least part of the scheduled switch off period such that the electrical power continues to be supplied during the at least part of the scheduled switch off period.

### BRIEF DESCRIPTION OF THE DRAWINGS

Various embodiments according to the present disclosure will be described with reference to the following, non-limiting illustrations, in which:

FIG. 1 is a diagrammatic representation of a use scenario of an example prior art timer;

FIG. 2 is a diagrammatic representation of the same use scenario shown in FIG. 1, but at a later time;

FIG. 3 is a flow chart showing steps in using an embodiment according to the present disclosure, wherein a threshold is pre-set;

FIG. 4 is a flow chart showing steps in using another embodiment according to the present disclosure, wherein the threshold is settable by a user;

FIG. 5 is a flow chart showing steps in using yet another embodiment according to the present disclosure, wherein the threshold is measured;

FIG. 6 is a flow chart showing steps in using a further embodiment according to the present disclosure, wherein the threshold is calculated;

FIG. 7 is a graph showing a method of calculating threshold using standby power supply, according to an embodiment consistent with the present disclosure;

FIG. 8 is a graph showing a method of calculating threshold using standby power supply, according to another embodiment consistent with the present disclosure;

FIG. 9 is a graph showing a method of calculating threshold using a histogram, or histogram-like means, according to yet another embodiment consistent with the present disclosure; and,

FIG. 10 is a graph showing an example power over time profile of a recharging battery.

### DETAILED DESCRIPTION

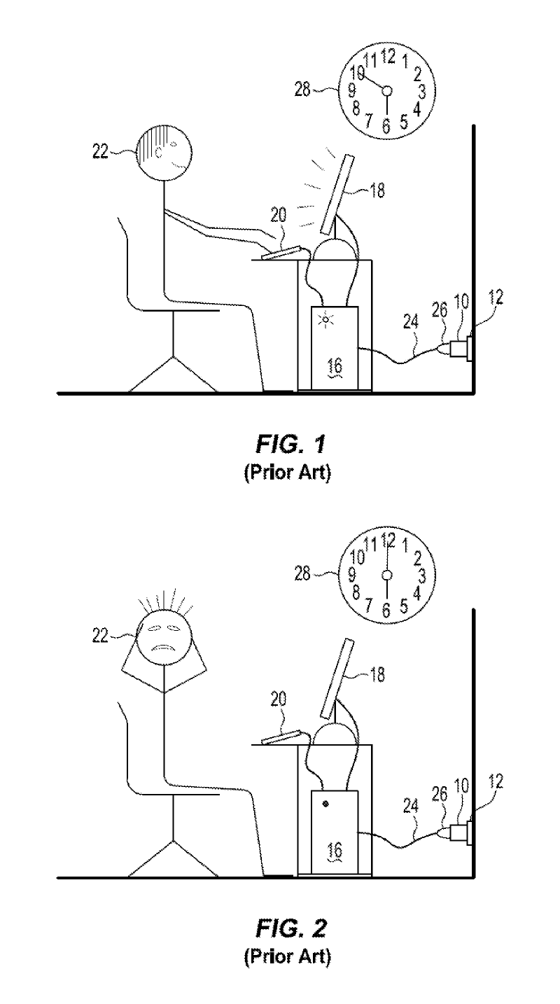

In FIG. 1 there is shown an example prior art timer 10 (which may also be referred to as an electrical control device, electrical supply timer, or electrical power supply timer), which is plugged in to a power point 12 (also referred to as a power outlet, a GPO, or a general power outlet) in a wall 14 of a facility. The power point (being a type of electrical outlet device) may have manual switches to turn on and turn of electrical power supply through the power point. However, it will be appreciated that in some embodiments the power point may not have such manual switches and power is generally supplied (if no timer is being used) by simply plugging in an apparatus to the power point, and power supply is generally stopped by unplugging the apparatus from the power point. An electrical apparatus, which in this example is a computer 16, is plugged in to the timer 10 via a power cord 24 and a plug 26, and the computer is connected to a graphical display 18 and a keyboard 20. A user 22 is shown as operating the computer.

The timer 10 is a separate, integral unit having a set of pins to plug in to the power point 12, and the timer has a socket for accepting the plug 26 of the computer. In this example, the timer is programmable to turn on and turn off at desired times by using a programming interface integral with the timer. The programming interface includes a display showing the programmed on and off times, along with the clock time and a calendar date, and also includes buttons which are pressed by the user 22 to set the desired on and off times.

Some timers are programmable with only one on time and one off time in a 24-hour period. Others are able to be programmed with multiple on and multiple off times within a 24-hour period. Yet other timers are programmable to have different, multiple on and off times for any given day of a week, a month or a year, so as to be very flexible.

Yet other timers are programmed with an external programming means such as a computer, a laptop, a smart phone, a computer tablet or the like. Further variations include timers which are integral with the power point unit, so that a user plugs an apparatus straight in to the socket of the power point, and can activate and program the timer to turn the power through the power point on and off.

The time between when the timer is set to switch on and switch off is referred to as an “on” period, or “switch on period”, where the timer allows electrical power to be supplied to an apparatus plugged in to the timer, and the time between when the timer is set to switch off and switch on is referred to as an “off” period or “switch off period”, where the timer prevents electrical power from being supplied to an apparatus plugged in to the timer. Some timers have multiple on and multiple off periods within a 24-hour period.

The timer 10 in the depicted example of FIG. 1 has been programmed to switch off at 6.00 pm. The time shown on the clock 28 is 5.50 pm. The user has forgotten that the timer has been set to cut the power supply at 6.00 pm, and keeps working.

However, as shown in FIG. 2, when the time 28 is 6.00 pm, the timer will go in to an off period where the electrical power is no longer supplied through the timer, and so the computer has the power cut and shuts down very suddenly. This can be a very annoying or even traumatic situation for the user 22, who may be doing a complex task that requires a number of steps. Sometimes users forget to save their work when operating a computer, and so a sudden loss of power can cause the work to be lost.

Another problem is that apparatuses such as computers can be damaged if subjected to sudden electrical power cut off when the computer is in its on mode. Typically, computers, and other apparatuses, will have a standby power mode. If the computer or other apparatus is in standby power mode, cutting off the electrical power supply does not cause the damage as is done if the power supply is cut when the computer is in on mode.

A computer in on mode may consume, for example, between 100 Watts (W) and 120 W, depending on what processes the computer is running. In standby mode, the computer may consume only a small amount of power, for example, between 2 W and 5 W. Some computers have a sleep mode where the electrical power consumed is between the amount consumed in standby mode and on mode, and may be, for example, between 10 W and 20 W, depending on what processes are still running in sleep mode.

Other devices, such as televisions and stereo systems also have standby mode and may consume similar amounts of power as computers when in this mode.

Though convenient, standby power consumes a large amount of power over time, such that, over a year, an apparatus which is standby mode when not being used may consume many Watt hours (Wh) of electrical power. This can be expensive and can be environmentally damaging, depending on how the electricity has been generated. Further, some users are reliant on electricity supplied by personal renewable energy generation means, such as solar panels, and may not wish to consume so much of this resource with standby power.

However, though timers can assist with power saving, as the above scenario suggests, a timer can also lead to apparatus switching off at times which are inconvenient according to scheduled on and off periods. The continuity module of the present example embodiment addresses this problem by only entering a power off period if an apparatus plugged in to the timer is consuming no power or consuming power at or below a level. If the apparatus is consuming power or consuming power above the level, then the continuity module overrides the scheduled off period so that power continues to be supplied to the apparatus, and there is no unwanted shut down.

The continuity module senses power supply to the apparatus by use of any suitable sensor. In one embodiment, the sensor may include a Rogowski coil for sensing current. In another embodiment, the sensor may include a Hall effect sensor for sensing current. The sensor will be located within a circuit so as to enable the sensing of power supply to the apparatus. Typically, the continuity module will be built in to the timer, so that the sensing can occur somewhere between a point where power supply enters the timer and where power supply leaves the timer.

In other embodiments, the timer itself will be integral with a power point unit or some other electrical outlet device, such as a light switch, so that the continuity module may be a separate unit from the timer, but adapted to work cooperatively with the timer and the electrical outlet device. The integral timer and electrical outlet device may be referred to as a timer/electrical outlet device system. In such embodiments, it is possible that the sensing of power supply to an apparatus occurs at a point in the supply outside of the timer, but somewhere within the electrical outlet device, though the continuity module is still enabled to work cooperatively with the timer so as to override a scheduled off period, if required.

In many applications, it will be useful for the continuity module to sense whether the power supply to an apparatus is likely to be at a level where the apparatus is in the on mode, at a level where the apparatus is in the standby mode, or the apparatus is off, such as for computers, televisions, stereo systems, and the like. In other applications, it will be useful if the continuity module senses whether the power supply is on or off to the apparatus, such as for lamps, lights, toasters, kettles and many other types of apparatus that do not typically have a standby power mode.

In order to operate effectively with apparatus having on, standby and off modes, an embodiment of the continuity module is adapted to sense whether the power being supplied is at or below a level, or whether the power is above that level. Alternatively, the continuity module may be configured to sense whether the power being supplied is below the level, or whether the power is at or above that level. In this way, if the power being supplied to the apparatus is sensed as being at or below, or only below the level, the apparatus is deemed to be either off (with no power being supplied) or in standby mode (with power being supplied somewhere below the level).

Accordingly, the continuity module may include or may be adapted to work cooperatively with a memory device and a processing device, wherein the memory stores the level as a threshold electrical power supply level, and wherein the processor operates to determine whether the power being supplied to the apparatus is at, above, or below the threshold. In embodiments, the memory device can be random access memory (RAM), flash memory or other types of digital memory devices, and the processing device can be a central processing unit (CPU), or the like. However, it will be understood that the storage of the threshold, and decision (or determination) process can be effected by other types of electrical, electronic or mechanical devices.

For example, the threshold may be 5 W, so that if the continuity module sensor senses an apparatus is being supplied with power at or below 5 W, the apparatus is determined to be either off or in standby mode. If it is determined that the apparatus is in standby mode or is off, then the continuity module will not override a switch off period of the timer, and the scheduled switch off time of the timer will be enacted and power supply to the apparatus will be stopped. If the sensor senses that the apparatus is being supplied with electrical power above 5 W, the apparatus is determined to be on and the scheduled switch off period is overridden so that the timer does not switch off power supply and the apparatus continues to be supplied.

In embodiments, the electrical power supply continuity module may be operable to sense, detect and/or calculate whether the power supply profile (the level of power drawn over a given period) is that of, or sufficiently similar to that of an apparatus recharging a rechargeable battery. In some circumstances, an apparatus, such as a laptop computer, mobile phone or other apparatus with rechargeable batteries, will be connected to an electrical outlet device for recharging, but will not be switched on for operation. In those circumstances, the power supply profile may be different to the power supply profile of the same apparatus when on and operating, and may also be different from the power supply profile of the apparatus if in stand-by mode, or some other mode with a low power draw compared with the power draw when fully on and operating. It will be understood that there is increasing use of non-sinusoidal power consuming devices, including switch mode supply devices. An example of a sinusoidal power consuming device is an incandescent light bulb. A laptop computer with a rechargeable battery is an example of a non-sinusoidal power consuming device, and uses a switch mode power supply. In embodiments, the electrical power supply continuity module is adapted to sense, detect and/or calculate a power supply profile for a non-sinusoidal device such as a switch mode power supply device.

The sensing, detecting, and/or calculating of the power supply profile could be implemented in various ways. In one embodiment, the module is operable to sense and record power supply to an apparatus over a period (the period may be limited to a chosen length of time, or could be unlimited), and the recorded supply can be notionally graphed by the module (or by some external device). In an example circumstance, the power supply profile at the beginning of a period will be relatively high, given the recharging may have just commenced, and the rechargeable battery will draw a larger level of power at the commencement of recharging, particularly if the battery has a very low amount of charge at that time. As time increases, the level of power required for recharging is likely to decrease, so that the power supply profile during the period will decrease, as the rechargeable battery becomes increasingly recharged.

When the battery is fully, or near-fully recharged, the power supply profile will reach a minimum, and the profile will plateau, so that the power supply level neither increases nor decreases over time. The module can be configured to recognize this plateau. In one embodiment, when the sensor senses the same power supply amount (being a relatively low amount compared with the power supply amount at the beginning of the period, and the power supply amount during the time of decreasing power level) for a chosen period, the rechargeable battery is determined to be fully, near-fully, or sufficiently-fully recharged.

For some recharging, or for some rechargeable battery types, the decreasing power supply over a period may be relatively rapid compared with the decreasing power supply of other recharging or other rechargeable battery types. Further, the maximum power level (at the beginning of recharging) and/or the minimum power level (at the end of recharging) may be different for different recharge cycles, or for different rechargeable batteries or battery types. However, the power supply profiles can be pre-set in the module to account for many, most or all different recharge cycles, different rechargeable batteries, or different battery types. Alternatively, the power supply profile for recharging could be learned by the module, in some embodiments, having initial profile parameters (for example, expected initial power draw level at recharge commencement, expected decreasing power draw level over time, and expected minimum power draw level at end of recharging), and then using subsequent one or more recharge examples to alter the initial profile parameters (for example, averaging successive examples, including weighted averaging with a greater weighting accorded to those recharge cycles determined to be complete recharge cycles).

The sensing during the recharging may be continuous, or could be periodic, with periods being chosen either by a manufacturer or user.

In other embodiments, the module is operable to circularly record a chosen period of power supply (that is, the module records power levels sensed for a chosen period, and then records over those initially recorded power levels with power levels sensed in a next period), so that, if there is a requirement to use previously sensed power levels, these are likely in the record. This circular recording may be used where a switch off period is scheduled to commence, wherein the module is able to use previously recorded power supply levels to calculate whether a recharging event is occurring. It will be understood that the circular recording can be used by the module to calculate and/or detect other behaviours, profiles and events different from recharging.

It will be appreciated that the sensing of recharging may be used in the module to avoid a timer switching off power supply during the recharging of an apparatus. For example, a user may set an apparatus to recharge, and at some time during the recharge period, the electrical supply timer is scheduled to switch to a supply off period. In such circumstances, the module, having sensed, detected and/or calculated that a recharging event is in progress, operates to over-ride the timer's switching to supply off period so that the recharging can continue. When the module senses, detects and/or calculates that the recharging period has finished (as discussed above, by sensing, detecting and/or calculating the low level plateau), the module operates to allow the timer to switch to the power supply off period, or the module otherwise causes the electrical outlet device to stop power supply. In other circumstances, the electrical supply timer may be scheduled to switch to a supply off period after the battery has recharged, but there remains a power supply at the minimum level (the low plateau level).

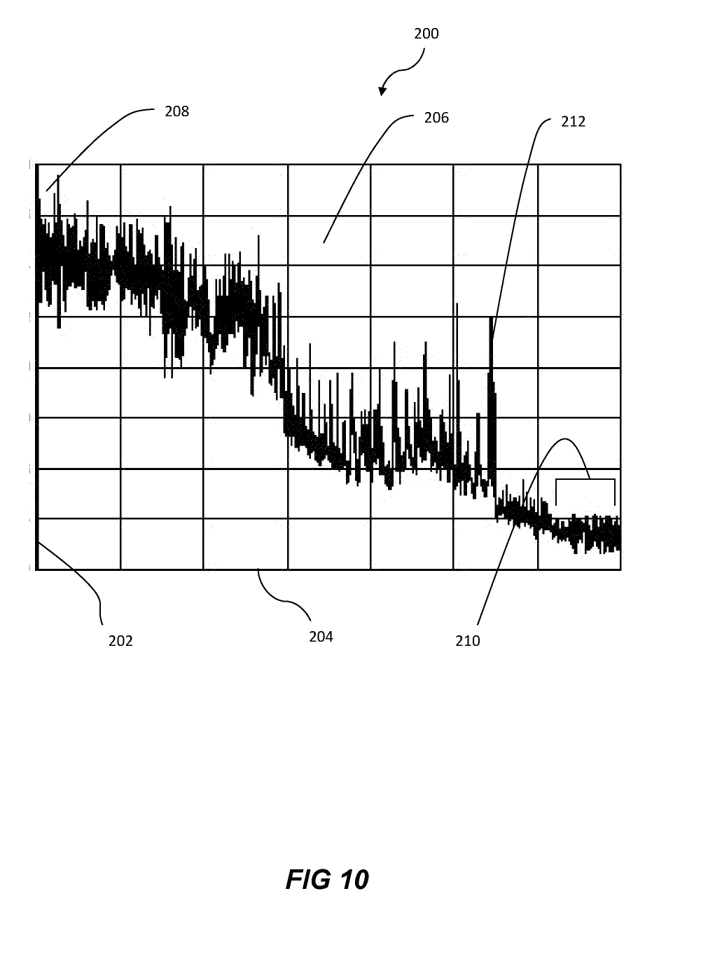

FIG. 10 shows an example graph 200 representing a possible power over time profile 206 during a battery recharging. The graph's Y axis represents power and the graph's X axis represents time. Towards the left of the graph the power consumed during recharging is relatively high 208, and decreases towards the right of the graph until reaching a low power plateau 210. The module can be configured to recognise this low power plateau and after a number of measurements of power at or sufficiently close to that plateau the module will allow commencement of the timer's switch off period.

It will be noted that the profile 206 in FIG. 10 is spikey (an example spike is shown at 212). It will be appreciated that this spikiness is a result, for example, of instantaneous power consumption events which may occur where the recharging is for a laptop computer battery while the laptop is operating. In such circumstances, the laptop may have requirements for more power for certain operations during the recharging period. The module can be configured to take account of this spikey power profile so as to not inadvertently switch the electrical output device (power point) to a power off period.

In embodiments, the sensor may operate to continuously sense the level of power being supplied. However, this continuous monitoring consumes a lot of energy, and it may therefore be more desirable to periodically monitor the power being supplied. For example, the sensor could be operated to sense power supply level at 10 second intervals, 30 second intervals, one minute intervals, or five minute intervals. When the sensor senses at the chosen periods, the sensing will be substantially instantaneous, and will operate to provide the desired accuracy of sensing in the shortest time for doing so. This will lessen the energy requirements for the sensors operation. Further, sensing the power supply level throughout an entire switch on period is not required in all applications because if the timer is set to be on with electrical power either suppliable to an apparatus or actually being supplied to the apparatus, there may be no need to sense whether the electrical power is actually being supplied.

Accordingly, the continuity module may be adapted to sense whether electrical power is being supplied to the apparatus only at a chosen time before the scheduled switch off period of the timer. The chosen time may be any length of time, and may include one minute, 30 seconds, 15 seconds, 10 seconds, or 5 seconds before the scheduled switch off period is to commence. In this way, if at the chosen time the sensor senses that power is being supplied, or being supplied above the threshold amount, the scheduled switch off time is overridden and power is not switched off such that at least a part of the scheduled switch off period is overridden. In other embodiments, the sensor may be operated to sense the power being supplied multiple times before the scheduled off period.

In one embodiment, if the scheduled switch off time has been overridden, then the continuity module continues sensing the power supply level throughout the scheduled switch off period (though the switch off period has not been enacted) so that if, during the switch off period, the user switches off the apparatus, or puts the apparatus into standby power mode, the continuity module operates with the timer to switch the power off, and reverts to a switch off period. The reversion to a switch off period may be a return to the scheduled switch off period, in which case the switch off period will end when the next scheduled switch on period begins. Alternatively, the switch off period could be a period of time that is shorter or longer than the originally scheduled switch off period. In this regard, the continuity module can be enabled to operate with the timer to reprogram the timer so as to alter switch on and switch off periods, as desired.

For example, if a user has extended power usage beyond a scheduled switch off time, the continuity module and timer could operate to penalize the user by altering the next switch on time to be later by the same amount that the user has exceeded the originally scheduled switch off time.

It will be understood that the sensing which continues after the scheduled off time (being a notional off time, as it has not been enacted) may be continuous sensing, or may be periodical sensing. As discussed above, the periodic sensing can occur at any chosen interval, and will be substantially instantaneous sensing at those intervals.

The threshold may be pre-set, could be set by the user, or may be set by sensing the power supply level to an apparatus when the apparatus is in standby mode. The threshold could also be calculated as an average of the power supply level to the apparatus in standby mode over a chosen period. The calculation of the threshold could also include determining a difference between standby mode power supply level(s) and on mode power supply level(s) to a particular apparatus. The threshold may be calculated so as to include a relatively small additional amount, which may be referred to as a delta, over the sensed and/or calculated level of power supply to the apparatus when in standby mode. Embodiments for setting the threshold will be discussed in more detail below.

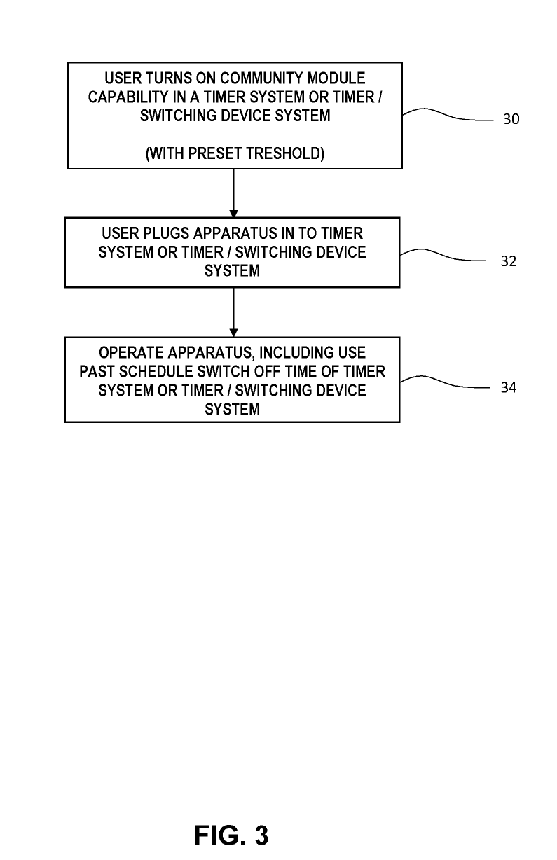

In one embodiment, as depicted in the flow diagram of FIG. 3, a continuity module with timer or timer/electrical outlet device system is provided to a user with a pre-set threshold. The threshold may be set by a manufacturer, set when imported into a country, or set at a point of sale. The threshold level may be determined by reference to specifications from a manufacturer of a particular apparatus which provide a nominal level of power consumption of the apparatus in standby mode. Further, the threshold may be determined by reference to specifications for a range of apparatuses, and setting the threshold at a highest of all specified levels of standby mode power levels from the specifications.

In the embodiment depicted in FIG. 3, the continuity module capability is optional in the timer or timer/electrical outlet device system. In order to activate the continuity module capability, the user must switch it on 30. This switching on of the continuity module may be done by a switch on the timer, or could be done by pressing a button on a graphical user interface if the timer is operated that way. The user then plugs the apparatus into the timer or timer/electrical outlet device system 32. If the timer is in a scheduled switch on period, the user will be able to operate the apparatus 34, and if the user is operating the apparatus at the chosen time before the switch off period is scheduled to commence, then the continuity module will override the switch off period so that power continues to be supplied to the apparatus through the timer or timer/electrical outlet device system during at least a part of the scheduled switch off period.

If the user then turns of the apparatus during the scheduled switch off period, or places the apparatus into standby power mode, the sensor senses that no power is being supplied or that power is being supplied at or below the pre-set threshold, and so the continuity module operates with the timer to commence a switch off period, or to revert to the originally scheduled switch off period.

If so desired, the user can also switch off the continuity module capability, in which case the timer will operate to its scheduled switching on and switching off times, without an override ability.

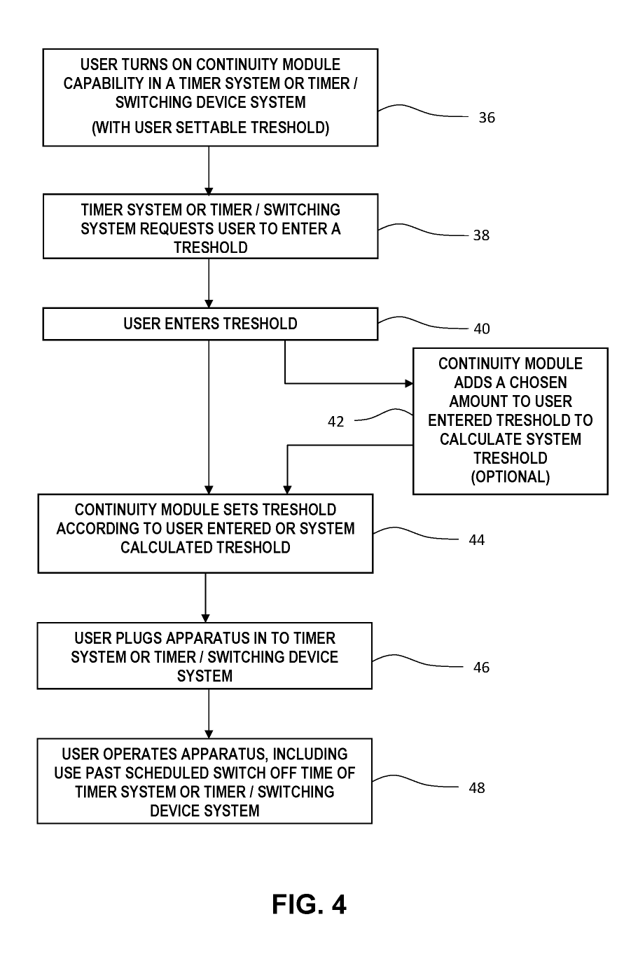

In an alternative embodiment depicted in FIG. 4, the threshold is settable by the user at or after purchase. The user turns on the continuity module capability 36, the timer or timer/electrical outlet device system requests that the user enters a threshold level 38, the user enters the desired threshold level 40. In one optional embodiment, the threshold level to be set is calculated by adding the threshold level entered by the user and adding a relatively small additional (delta) amount 42. This system calculated threshold including the delta amount can assist in preventing unwanted overriding due to the threshold being exceeded with small variations in the standby mode power consumption level.

The continuity module sets the threshold either according to the user entered or system calculated threshold 44. The user can then plug in the apparatus 46, and use the apparatus with the timer and continuity module providing override 48 when needed.

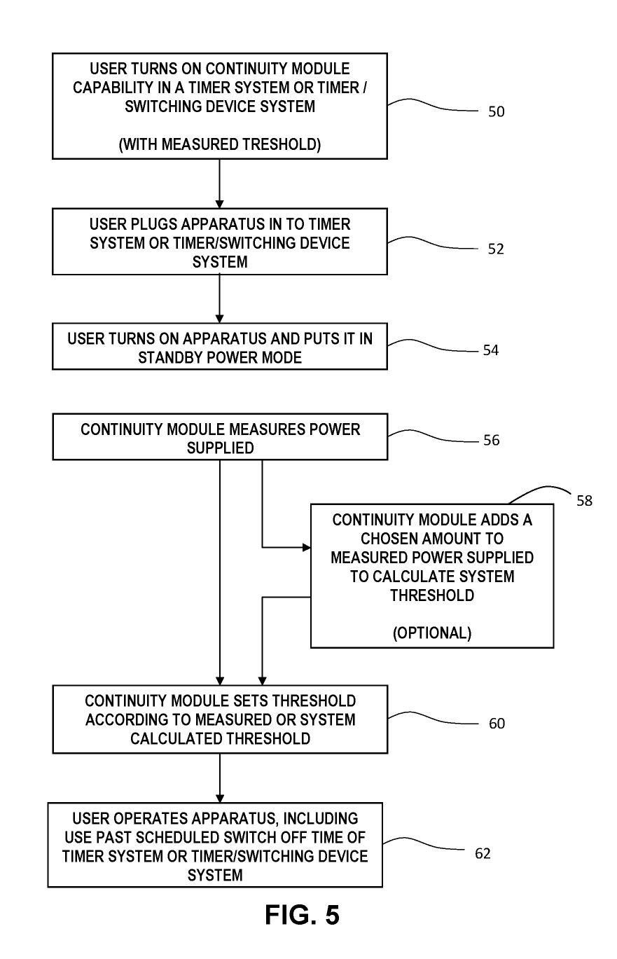

In a further optional embodiment depicted in FIG. 5, the threshold is determined by measuring the power supply level of the apparatus while it is in standby mode. The user switches on the continuity module capability 50, the user then plugs an apparatus in to the timer or timer/electrical outlet device system 52. The apparatus is then turned on a placed in standby power mode 54. Either automatically, or by the user activating the module, the continuity module measures (senses) the power being supplied to the apparatus while in standby 56. Again, an option is to add a delta amount to the measured level 58 to produce a system calculated threshold. The continuity module then sets 60 the threshold according to the directly measured level 56, or the system calculated level 58. The user proceeds to operate the apparatus with the continuity module activated and with the threshold set 62.

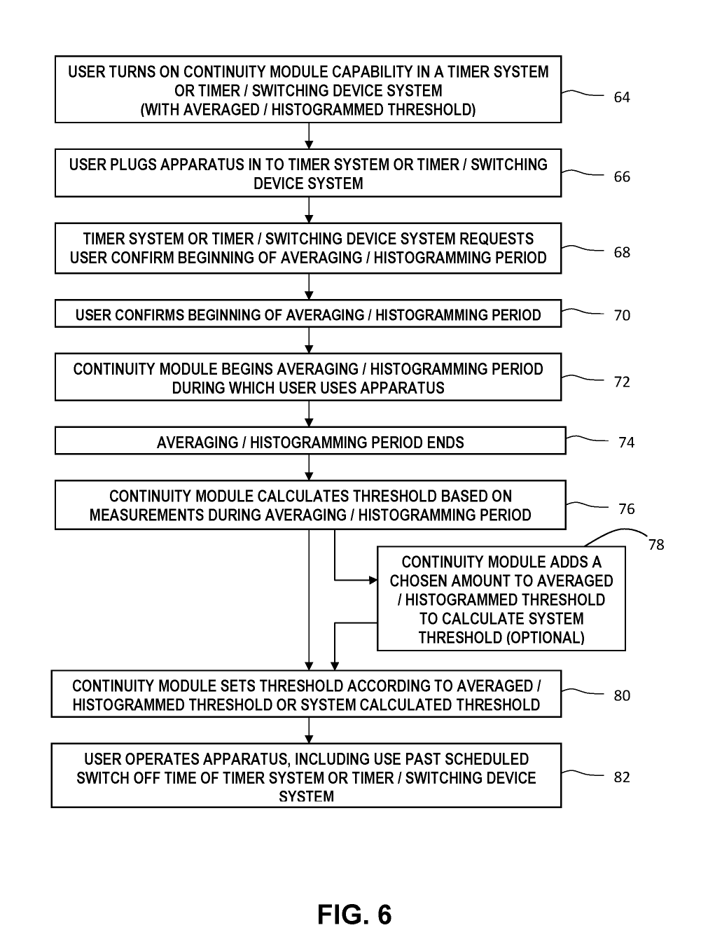

In yet another embodiment depicted in FIG. 6, the threshold level to be set is calculated by averaging levels of standby power over a chosen period, or can be determined by using a histogramming method. The user turns on the continuity module capability 64, plugs an apparatus in to the timer or timer/electrical outlet device system 66, the user is then prompted to confirm that the averaging or histogramming period should commence 68, and the user confirms this 70.

The averaging or histogramming period could be, for example, 24 hours, but may be a shorter or longer period. The period may be user selectable. Further, in some embodiments the averaging or histogramming could be done continuously or repeatedly for set periods so as to improve the accuracy of the threshold level. These variations could be selectable options for the user.

After the user confirms that the period for averaging/histogramming should commence, the continuity module begins measuring (sensing) the power supply level to the apparatus over the period 72.

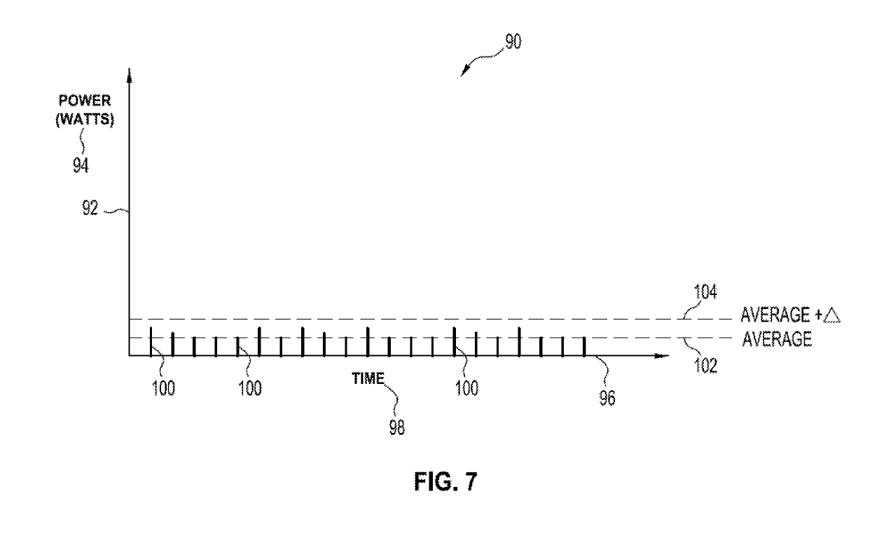

In one embodiment of the averaging (refer to FIG. 7, in which the power 94 is graphed 90 on the Y axis 92, and time 98 is graphed on the X axis 96), the user is required to leave the apparatus in standby mode for the entire period 98, and when the period ends 74, the variations 100 in measured standby power supply 92 are averaged 102 over that period 76. The measurement can be continuous or can be made periodically over the period, but FIG. 7 shows a periodical measurement. A delta amount 104 can optionally be added to the calculated average 102.

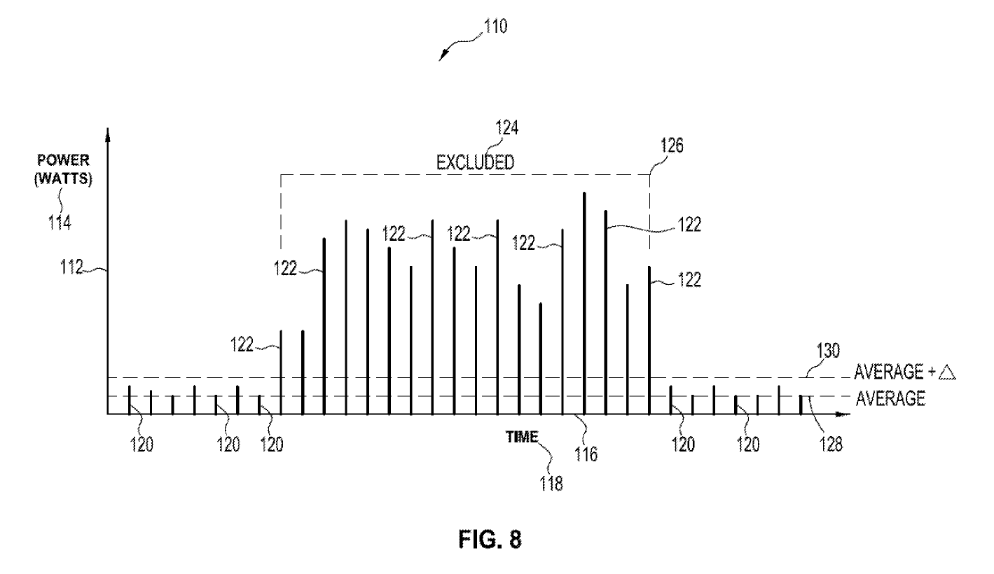

In another embodiment of the averaging (refer to FIG. 8, in which the power 114 is graphed 110 on the Y axis 112, and time 118 is graphed on the X axis 116), the user can operate the apparatus as desired in on mode and in standby mode, so long as there is at least a part of the period during which the apparatus is in standby mode. The averaging 128 is performed only on those measurements 120 which are determined to be under a chosen or calculated level, while all measurements 122 above the chosen or calculated level are excluded 124 from the averaging, as these are defined to be power supply levels indicative of the apparatus being in the on mode, or in some variations, sleep mode. The exclusion level may be calculated by subtracting one or more standard deviations from the average of all measured power levels over the period. A delta amount 130 can optionally be added to the calculated average 128.

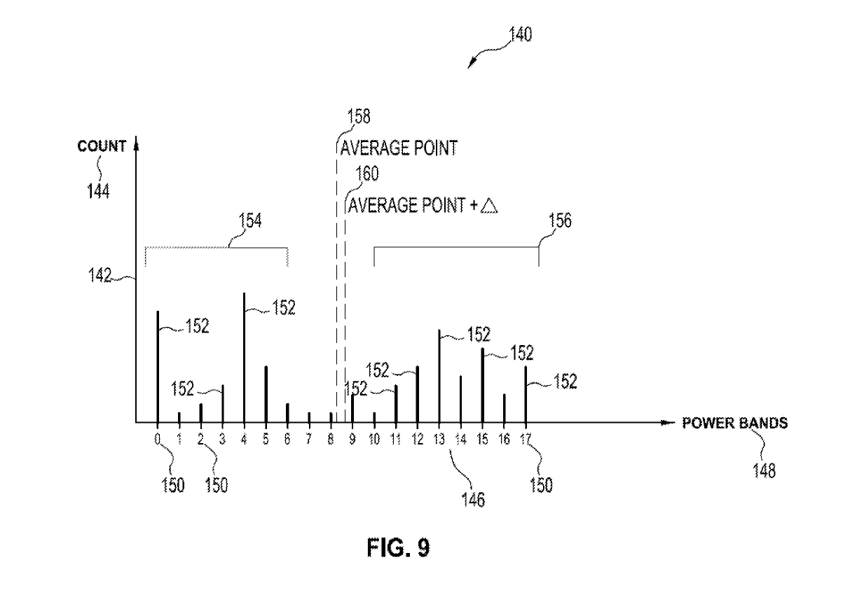

In a variation, a histogramming method may be used by counting the number of times the instantaneous power supply level is within one of a plurality of chosen power level bands, defining that the standby power supply level is at or below a chosen point between higher power level bands having a high count and lower power level bands having a high count, and defining that non-standby power supply level is above the chosen point (refer to FIG. 9, in which the count 144 is graphed 140 on the Y axis 142, and the power bands 148 are graphed on the X axis 146).

The number of bands 150 may be chosen so as to provide a desired accuracy. For example, over a range of 3000 W, there may be 1000 bands, with each band being a 3 W range. The bands can be evenly distributed or may vary so that at certain ranges within the entire range the number of bands is greater than at other ranges. In FIG. 9, there is shown only 17 bands 150, which cover a range of 34 W, meaning each band represents a range of 2 W.

The count distributions 152 show a “hump” 154 around the 4th power band and another “hump” 156 around the 13th to 15th power bands. These may be humps which show a difference between standby power 154 and sleep mode power 156 in a computer. The point 158 for determining the difference between the two power profiles 154, 156 may be chosen as a mid-point between the two. A delta amount 160 can optionally be added to the chosen point 158, which then is set as the threshold.

Referring back to FIG. 6, when the measurement period finishes 74, calculation is performed 76 on the measurements according to any one of the averaging or histogramming methods described above. Optionally, the delta amount is added to the calculated result 78 to produce a system calculated threshold. The threshold is then set 80 according to the averaged/histogrammed calculated threshold or according to the system calculated threshold. The user then proceeds to operate the apparatus 82.

It will be understood that the measuring, calculation and determination to establish the threshold to be set can be effected by the memory and processor of the continuity module, but could also be effected by another unit or units working in cooperation with the continuity module.

In one or more embodiments, the electrical power supply continuity module is adapted for electrical appliances having two or more distinguishable states of operation (two or more distinguishable states (or levels) of power consumption). For example, an electrical appliance may have a low power “stand-by” state and a high power “in-use” state. Other example electrical appliances may operate with a continuous, near constant current draw or an “off” state, and yet other electrical appliances may operate with an intermittent on/off current draw.

In one or more other embodiments, the electrical power supply continuity module can control electrical power supply timer schedules for electrical outlet devices (power outlets) other than the electrical outlet device into which the electrical appliance being sensed, measured and/or controlled is plugged. For example, in a double power outlet, the electrical power supply continuity module may be operated with power supply sensed for an electrical appliance plugged into one of the sockets in the power outlet, and can be used to control the electrical power supply timer for an apparatus plugged into the other socket of the electrical outlet device. Sometimes this is referred to as master/slave operation. It is envisaged that such operation can be extended to multiple socket power boards and similar electrical outlet devices so that the electrical power supply continuity module can receive indications of sensed electrical power supplied to one or more electrical appliances and can be operated to control the scheduling overrides of one or more other electrical appliances. It also envisaged that the electrical power supply continuity module can operate with a network of electrical outlet devices, for example, in a room, a house or an office, to control the scheduling overrides of one or more other electrical appliances on the network.

In one or more embodiments, the electrical power supply continuity module is operable to calculate a time period between a particular power supply sensing event and an end of a scheduled switch off period. In some circumstances, it may be desirable to maintain an override of the scheduled switch off period if the calculated time period is sufficiently short. For example, in an embodiment, the electrical power supply continuity module may have been operating for seven and a half hours to override an eight hour scheduled off period, wherein the module operates in five minute periods to receive indications from a sensor of power being supplied to the respective electrical appliance above the threshold level. In this example and embodiment, the module may be programmed or otherwise configured to maintain the override until the end of the eight hour scheduled switch off period if the power supply is sensed as being above the threshold level during the periodical sensing event at seven hours and 35 minutes.

It will be appreciated that in embodiments, the maintenance of an override until the end of the respective scheduled switch off period may be determined based on a chosen or calculated residual time of the scheduled switch off period. The chosen residual time may be pre-set or entered by a user. The calculated residual time may be determined as a percentage of the scheduled switch off period either elapsed or to come.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not and should not be taken as an acknowledgement or any form of suggestion that the prior art forms part of the common general knowledge.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. An electrical power supply continuity module for an electrical power supply timer operable with an electrical outlet device, the electrical power supply timer having at least one scheduled switch off period for stopping electrical power supply through the electrical outlet device, the electrical power supply continuity module operable with a sensor for sensing electrical power supplied to an electrical apparatus by the electrical outlet device,
wherein the electrical power supply continuity module is operable to receive from the sensor an indication of electrical power supply to an electrical apparatus at a chosen time before a scheduled switch off period of the electrical power supply timer, the continuity module operable to override at least part of the scheduled switch off period such that electrical power is supplied during at least part of the scheduled switch off period.

2. The continuity module according to claim 1, operable to allow the override if receiving an indication from the sensor of electrical power supply to the electrical apparatus at or above a power supply threshold.

3. The continuity module according to claim 2, wherein the chosen power supply threshold is pre-set.

4. The continuity module according to claim 2, wherein the power supply threshold is calculated from a chosen or a measured standby electrical power supply level.

5. The continuity module according to claim 4, wherein the calculation includes a chosen additional amount above the chosen or the measured electrical standby power supply level.

6. The continuity module according to claim 2, wherein the power supply threshold is calculated by measuring standby power supply level of an apparatus over a chosen period and determining an average standby power supply level over that period.

7. The continuity module according to claim 6, wherein measuring the standby power supply level includes determining a difference between standby power supply level and non-standby power supply level of the apparatus.

8. The continuity module according to claim 7, wherein the difference between standby power supply level and non-standby power supply level is determined by periodically measuring substantially instantaneous power supply over the chosen period, counting the number of times the instantaneous power supply level is within one of a plurality of chosen power level bands, defining that the standby power supply level is at or below a chosen point between higher power level bands having a high count and lower power level bands having a high count, and defining that non-standby power supply level is above the chosen point.

9. The continuity module according to claim 6, wherein the calculation includes a given additional amount above the determined average standby power level.

10. The continuity module according to claim 1, wherein the continuity module includes memory and a processor.

11. The continuity module according to claim 10, wherein any one or more of setting the threshold, pre-setting the threshold, storing the standby power supply level, storing the chosen additional amount, storing the chosen period, determining the average, calculating the threshold, measuring the standby power level, storing the chosen power level bands, defining the standby and non-standby power supply level, and determining a difference, are performed by the continuity module using the memory and/or the processor.

12. The continuity module according to claim 1, wherein the sensor senses electrical power supply to the apparatus between notional commencement of the scheduled switch off period and commencement of a next scheduled switch on period, and, if the sensor senses no electrical power supply to the apparatus or senses power supply below a chosen level defined as being no electrical power supply to the apparatus, a switch off period is commenced.

13. The continuity module according to claim 2, wherein the sensor senses electrical power supply to the apparatus between notional commencement of the scheduled switch off period and commencement of a next scheduled switch on period, and, if the sensor senses power supply to the apparatus below the threshold, a switch off period is commenced.

14. The continuity module according to claim 12, wherein the commenced switch off period is the originally scheduled switch off period.

15. The continuity module according to claim 12, wherein the sensing after the notional commencement of the scheduled switch off period is periodical.

16. A method of continuing electrical power supply including receiving an indication of sensed electrical power supplied to an electrical apparatus from an electrical outlet device operating with an electrical power supply timer, wherein, if the electrical power supply is sensed at a chosen time before a scheduled switch off period of the electrical power supply timer, at least part of the scheduled switch off time is overridden such that the electrical power continues to be supplied during the at least part of the scheduled switch off period.

17. A method according to claim 16, wherein the override is allowed if electrical power supply to the apparatus is sensed at or above a power supply threshold.

18. A system enabled to provide electrical power supply continuity including an electrical power supply continuity module according to claim 1 and the electrical power supply timer.

19. The system according to claim 18, further including the electrical outlet device.

20. A system enabled to provide electrical power supply continuity including an electrical power supply continuity module according to claim 1 and the sensor.
